(19) United States
(12) Patent Application Publication
(10) Pub. No.: US 2010/0138662 A1
(43) Pub. Date: Jun. 3, 2010

(54) DIGITAL SIGNATURE ASSURANCE SYSTEM, METHOD, PROGRAM AND APPARATUS

(75) Inventor: Tatsuro Ikeda, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 12/698,327

(22) Filed: Feb. 2, 2010

Related U.S. Application Data
(62) Division of application No. 11/080,824, filed on Mar. 16, 2005.

(30) Foreign Application Priority Data
Mar. 18, 2004 (JP) 2004-077734

(51) Int. Cl. H04L 9/32; H04L 9/06

(52) U.S. Cl. 713/179; 380/277

(57) ABSTRACT

According to respective embodiments of the present invention, it is possible to verify a security environment of an digital signature and assure validity of the digital signature. For example, in the case of generating the digital signature, the assertion for asserting a key management system and a user authentication system is generated, the conversion processing is applied to both of the digital signature and the assertion, and the acquired digital signature, assertion, and conversion value are outputted. Therefore, it is possible to verify validity of the assertion on the basis of the conversion value and verify the security environment of the digital signature on the basis of the key management system and the user authentication system included in the assertion. Accordingly, the validity of the digital signature can be assured.

### CROSS-REFERENCE TO RELATED APPLICATIONS

This application is based upon and claims the benefit of priority from prior Japanese Patent Application No. 2004-077734, filed Mar. 18, 2004, the entire contents of which are incorporated herein by reference.

### BACKGROUND OF THE INVENTION

1. Field of the Invention

The present invention relates to an digital signature assurance system for assuring validity of an digital signature, its method, and its program, and particularly, the present invention relates to an digital signature assurance system capable of verifying a security environment of the digital signature and assuring validity of the digital signature, its method, its program, and its apparatus.

2. Description of the Related Art

At the present day, in a field of a Web service and the like, the digital data such as extensible markup language (XML) data is frequently exchanged between systems. When the digital data is exchanged via an open network, it is an important requirement to assure a reliability of the digital data. As a method to satisfy this requirement, an digital information assurance technology attracts attention.

As this information assurance technologies, an digital signature technology has been generally known and this technology is used to assure that a content of the digital information is not falsified and who a creator is thereof. However, the digital signature technology itself serves to prove validity and authenticity of the digital information. The information assurance technology makes it possible to “assurance reliability of the digital information” by combining such digital signature technology and a assurance infrastructure technology such as a public key infrastructure (PKI) and the like.

The digital signature technology is generally based on secure management of a private key for giving an digital signature. The validity of the digital signature is also based on the secure management of the private key. In other words, according to the digital signature technology, based on the secure management of the private key, by giving reliability to the digital signature due to the private key, a reliability of the digital information having the digital signature given thereto is assured.

However, in consideration of the present invention, according to the above-described digital signature technology, when the basis that the private key is safely managed collapses, for example, when the private key leaks out outside, someone other than the owner of the private key can generate the valid signature.

Therefore, when exchanging the digital information via the open network, it is conceivable that a side receiving the digital information having the digital signature may order verification of a security environment (hereinafter, referred to as a security profile) such as a key managing system and a user authentication system and the like.

In the meantime, a first prior art document information indicate locations of the prior art documents related to the present invention.

The first prior art document information is “SAML (a security assertion specification due to OASIS)”, OASIS, [retrieved on Oct. 8, 2003], <URL: http://www.oasis-open.org/comittees/download.php/3400/oasis-sstc-saml-1.1-pdf-xsd.zip>, and the first prior art document information represents a URL of a SAML standard. The SAML standard means a standard related to assertion of the information for making a declaration of a security profile to be used for a single sign-on technology or transmitting it differently from the digital signature assurance technology.

### BRIEF SUMMARY OF THE INVENTION

An object of the present invention is to provide an digital signature assurance system, method, program, and apparatus capable of verifying a security environment of the digital signature and assuring validity of the digital signature.

A first aspect of the present invention is an digital signature assurance system for generating an digital signature from a signature target by using an digital signature generation key upon receipt of a generation request of the digital signature and assuring validity of this digital signature, the system comprising: a key management device configured to manage the digital signature generation key in accordance with a key management system that has been set in advance for each generation request source of the digital signature; a user authentication device configured to execute user authentication of the generation request source of the digital signature in accordance with a user authentication system that has been set in advance upon receipt of the generation request of the digital signature; an digital signature generation device configured to generate the digital signature by using the corresponding digital signature generation key among the key management device when a result of this user authentication indicates validity; an assertion generation device configured to generate the assertion for asserting the key management system and the user authentication system; means for applying the conversion processing to both of the digital signature and the assertion and relating the assertion and the assertion each other by the acquired conversion value; and an output device configured to output the digital signature, the assertion, and the conversion value.

According to the first aspect of the invention, in the case of generating an digital signature, generating the assertion for asserting a key management system and a user authentication system and applying conversion processing to the both of the digital signature and the assertion, the acquired conversion value, digital signature, and assertion are outputted. Accordingly, it is possible to verify the validity of the assertion by the conversion value, and on the basis of the key management system and the user authentication system, it is possible to verify the security environment of the digital signature and thereby, the validity of the digital signature can be assured.

In the meantime, the first invention represents a set of all elements (device and means) in a format of “system”, however, it is obvious that respective sets of all elements, element related to the key management or related to a user authentication may be represented arbitrarily, for example, as “apparatus”, “method”, “computer readable storage medium” or “program” and the like.

### BRIEF DESCRIPTION OF THE SEVERAL VIEWS OF THE DRAWING

FIG. 1 is a pattern diagram showing a configuration of an digital signature assurance system according to a first embodiment of the present invention;

FIG. 2 is a sequence diagram for explaining an operation according to the embodiment;

FIG. 3 is a sequence diagram for explaining a modified example of the operation according to the embodiment;

FIG. 4 is a pattern diagram showing a configuration of an digital signature assurance system according to a second embodiment of the present invention;

FIG. 5 is a pattern diagram showing a configuration of an XML document transmission system to which an digital signature assurance system according to a third embodiment of the present invention is applied;

FIG. 6 is a sequence diagram for explaining an operation according to the embodiment;

FIG. 7 is a pattern diagram showing a configuration of an digital commerce system to which an digital signature assurance system according to a fourth embodiment of the present invention is applied;

FIG. 8 is a sequence diagram for explaining an operation according to the embodiment;

FIG. 9 is a pattern diagram showing a configuration of an digital commerce system to which an digital signature assurance system according to a fifth embodiment of the present invention is applied; and

FIG. 10 is a sequence diagram for explaining an operation according to the embodiment.

### DETAILED DESCRIPTION OF THE INVENTION

With reference to the drawings, the preferred embodiments of the present invention will be described below.

### First Embodiment

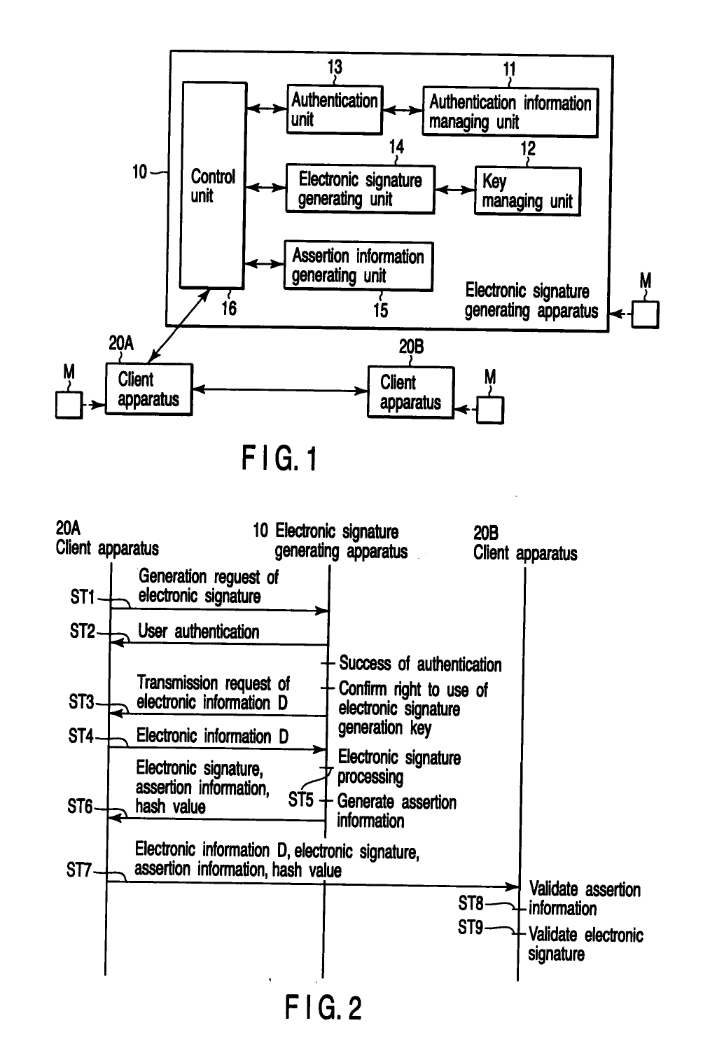

FIG. 1 is a pattern diagram showing a configuration of an digital signature assurance system according to a first embodiment of the present invention.

In this digital signature assurance system, an digital signature generating apparatus 10 and client apparatuses 20A and 20B are connected each other via a network. However, the connection between a client apparatus 20B and the digital signature generating apparatus 10 is not shown because this is not important for explanation of the operation. In addition, the case of the client apparatuses 20A and 20B is a typical example in the case of two apparatuses in one or more apparatuses. In the same way, the case of the digital signature generating apparatus 10 is a typical example in the case of one apparatus in one or more apparatuses. Each of the apparatuses 10, 20A, and 20B can exchange digital information each other, and with respect to an exchange system of the digital information, an arbitrary system can be used.

In addition, the apparatuses 10, 20A, and 208 may be realized by a hardware device such as an IC chip and the like having a tamper proof and may be realized by a combination of each hardware device and each software. The software has been installed in a computer of each of apparatuses 10, 20A, and 20B from a storage media M or the network in advance and the software is composed of a program for realizing the function of each of the apparatuses 10, 20A, and 20B. The example using the software can be also realized in the following each embodiment as the storage media M is also shown in FIGS. 4, 5, 7, and 9 to be described later.

The digital signature generating apparatus 10 includes an authentication information managing unit 11, a key managing unit 12, an authentication unit 13, an digital signature generating unit 14, an assertion generating unit 15, and a control unit 16.

In accordance with a user authentication system that has been set in advance, the authentication information managing unit 11 has a function to manage an credential as a determination standard of authentication of the user and a function to provide the credential to the authentication unit 13 in response to a request from the authentication unit 13.

The key managing unit 12 has a function to safely manage an digital signature generation key (for example, a private key in a public key encryption system) in accordance with a key management system that has been set in advance and a function to provide the digital signature generation key of the user to the digital signature generating unit 14 in response to a request from the digital signature generating unit 14.

The authentication unit 13 is controlled by the control unit 16 and the authentication unit 13 has a function to execute a user authentication on the basis of the authentication information of the user notified from the client apparatus 20A of a source of a generation request of the digital signature and the credential of the user in the authentication information managing unit 11 upon reception of a request to generate an digital signature in accordance with the user authentication system that has been set in advance and a function to transmit a result, of the user authentication to the control unit 16.

The digital signature generating unit 14 is controlled by the control unit 16 and the digital signature generating unit 14 has a function to generate the digital signature from the digital information of an signature target by using the corresponding digital signature generation key in the key managing unit 13 when a result of this user authentication indicates validity and a function to transmit the digital signature to the control unit 16.

The assertion generating unit 15 is controlled by the control unit 16 and the assertion generating unit 15 has a function to generate the assertion for asserting the key management system and the user authentication system and a function to transmit the assertion to the control unit 16.

The assertion may include the first profile information with related to user authentication such as a user authentication system and the like and the second profile information with related to the key management such as the key management system of the digital signature generation key and its security level and the like (for example, ISO17799, ISO15408 and the like) and the assertion is made by providing an evidentiary base to these first and second profile information. In the meantime, the assertion may include or may not include a security level.

Arbitrary relevant information may be added to the assertion other than the information asserting validity of the digital signature. For example, the third profile information with related to the user can be added. These assertion may be included in the same information or they may be formed in different information patterns with being related each other.

As a technology to represent the assertion, for example, assertion is available. The assertion is the information to declare or transmit a security profile of the user and assures the validity of the digital signature on the basis of reliability of the identity (the profile information group such as the attribution information and the authentication information with related to the individual and the user) of the user.

The control unit 16 may control the operation of respective units 13 to 15 upon reception of a generation request of the digital signature from the client apparatuses 20A and the control unit 16 has a function to provide a hash function (the conversion processing) to both of the digital signature acquired from the digital signature generating unit 14 and the assertion acquired from the assertion generating unit 15 and to relate the digital signature and the assertion each other by the acquired hash value (the conversion value) and a function to output this digital signature, the assertion, and the hash value to the client apparatuses 20A.

In the meantime, the hash function and the hash value are not indispensable and they can be replaced with arbitrary methods to relate the digital signature and the assertion each other. For example, the hash function may be replaced with the digital signature processing using a private key that is proper to the digital signature generating apparatus 10 and the hash value may be replaced with the digital signature (due to the private key proper to the digital signature generating apparatus 10). In addition, the assertion is related to the hash value or the digital signature (due to an digital signature generation key of the user). Preferably, all or a part of the digital signatures (due to an digital signature generation key of the user) (or the hash value), for example, a signature value and the like may be included in a field of the assertion.

The above-described digital signature generating apparatus 10 is preferably mounted on a server having a general communication function, an application execution function, and a storage media. However, the digital signature generating apparatus 10 may be mounted on a smart card represented by an IC card and the like. The digital signature generating apparatus 10 may be mounted on a portable device owned by an individual such as Handset and personal digital assistant (PDA) and the like. In the case of mounting the digital signature generating apparatus 10 on the smart card or the portable device, it is preferable that respective units 11 to 16 of the digital signature generating apparatus 10 are mounted on an IC chip having the tamper proof.

On the other hand, the client apparatuses 20A and 20B are terminal devices having a normal computer function and a communication function and they may execute different operations depending on an operation of the user.

The client apparatus 20A is used for transmitting the digital information when exchanging the digital information between respective apparatuses 20A and 20B, and the client apparatus 20A has the following functions (f20A-1) to (f20A-3) in addition to the function of a normal computer terminal.

(f20A-1): A function to transmit a generation request of the digital signature with respect to the digital information of a signature target by the operation of the user.
(f20A-2): A function to execute a mediation processing of the user authentication in accordance with an authentication request from the digital signature generating apparatus 10.
(f20A-3): A function to transmit the digital signature, the assertion and the hash value received from the digital signature generating apparatus 10 to the client apparatus 20B.

The client apparatus 20B is used for receiving the digital information when exchanging the digital information between respective apparatuses 20A and 20B and the client apparatus 20B has a function to verify the assertion and the digital signature by the operation of the user when receiving the digital information, the digital signature, the assertion, and the hash value from the client apparatus 20A.

In this case, the verification of the assertion can be executed by checking the hash value acquired by providing the hash function to the assertion and the digital signature against the hash value received from the client apparatus 20A and establishing correspondence of the both. In the meantime, any of the operator or the client apparatus 20B may determine whether or not the contents of the assertion indicate a desired security environment. In addition, verification of the digital signature can be executed on the basis of the public key certification of the user of the client apparatus 20A and the like.

Next, the operation of the above-described digital signature assurance system will be described with reference to the sequence diagram of FIG. 2 below. In the meantime, the following explanation is related to an example to exchange the digital information between two client apparatuses 20A and 20B and in order to simplify the explanation, the explanation is made taking an example to transmit the digital information D from the client apparatus 20A to the client apparatus 20B.

The client apparatus 20A transmits the generation request of the digital signature to the digital signature generating apparatus 10 by the operation of the user (ST1). In the meantime, the user or the client apparatus 20A may authenticate the digital signature generating apparatus 10 before the step ST1 according to need and the user or the client apparatus 20A may establish a secure communication path to the digital signature generating apparatus 10.

In the digital signature generating apparatus 10, when the authentication unit 13 receives the generation request of the digital signature via the control unit 16, this authentication unit 13 executes the user authentication for the user of the client apparatus 20A in accordance with the user authentication system that has been set in advance (ST2).

Specifically, the authentication unit 13 requires transmission of the authentication information from the user and the authentication unit 13 executes the user authentication on the basis of the acquired authentication information of the user and the credential of the user in the authentication information managing unit 11 and transmits a result of the user authentication to the control unit 16.

The control unit 16 confirms that the user has a right to use of an digital signature generation key required by this user or not and when the result of the user authentication indicates validity, and if the right to use can be confirmed, the control unit 16 transmits a transmission request of the digital information D of the signature target to the client apparatus 20A (ST3).

Receiving the transmission request of the digital information D, the client apparatus 20A transmits the digital information D to the digital signature generating apparatus 10 due to the operation of the user (ST4). In the meantime, the client apparatus 20A may transmit the digital information D when transmitting the generation request of the digital signature.

In any case, in the digital signature generating apparatus 10, the digital signature generating unit 14 receives the digital information D via the control unit 16 and the corresponding digital signature generation key in the key managing unit 12.

The digital signature generating unit 14 provides the digital signature processing to the digital information D by using this digital signature generation key to generate an digital signature (ST5) and transmits the acquired digital signature to the control unit 16. The digital signature may include the digital information D as a target of the signature and a system of the digital signature depends on the digital signature system to be used.

Receiving the digital signature, the control unit 16 transmits the key management system and the user authentication system with related to the generation request source of this digital signature to the assertion generating unit 15.

The assertion generating unit 15 generates the assertion for asserting the key management system and the user authentication system and transmits the acquired assertion to the control unit 16.

The control unit 16 applies the hash function to both of the digital signature and the assertion and transmits the acquired hash value, digital signature, and assertion to the client apparatus 20A (ST6).

The client apparatuses 20A transmits the digital information D, the digital signature, the assertion, and the hash value to the client apparatus 20B due to the operation of the user (ST7).

Then, the client apparatus 20B verifies the assertion by the hash value due to the operation of the operator (ST8), and certifies that the assertion is not falsified when the verification result indicates the validity. Subsequently, the client apparatus 20B verifies the security environment of the digital signature on the basis of the key management system and the user authentication system included in the assertion, and if the contents of the assertion satisfies the desired security environment, the client apparatus 20B determines that the user is a valid user or owner of the digital signature key.

Next, the client apparatus 20B verifies the digital signature on the basis of the public key of the user of the client apparatus 20A (ST9), and if the verification result is valid, the validity of the digital signature is assured and further, the validity of the digital information D is assured.

As described above, according to the present embodiment, in the case of generating the digital signature, the assertion to assert the key management system and the user authentication system is generated, the hash function is provided to both of the digital signature and the assertion, and the acquired hash value, digital signature, and assertion are outputted. Thereby, the validity of the assertion can be verified and on the basis of the key management system and the user authentication system included in the assertion, the security environment of the digital signature can be verified. Accordingly, due to these verification, it is possible to assure validity of the digital signature.

Thereby, it is possible to assure that a transmitter of the digital signature (namely, the user of the client apparatus 20A) is an owner or a person who has a validate right to use of the digital signature generation key and further, a third party including a receiver of the digital signature can confirm the contents of this assurance.

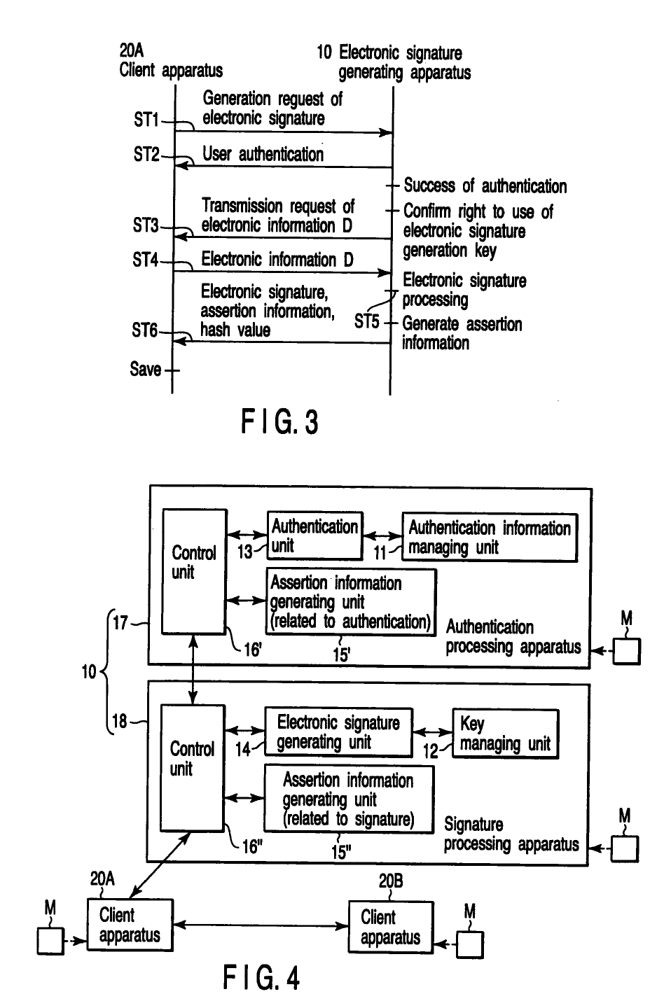

According to the present embodiment, the explanation is made taking exchange of the digital information between two client apparatuses 20A and 20B as an example, however, the present embodiment is not limited to this and may be modified so that one client apparatus 20A may execute steps ST1 to ST6 against the digital signature generating apparatus 10 to save the acquired digital signature, assertion, and hash value in the client apparatus 20A itself or the storage media such as a floppy disk (registered trademark) and the like as shown in FIG. 3. In this case, it is possible to verify validation of the digital information D after the fact.

### Second Embodiment

FIG. 4 is a pattern diagram showing a configuration of an digital signature assurance system according to a second embodiment of the present invention. Giving the like reference numerals to the like elements as FIG. 1, its detailed explanation is herein omitted and the different elements are mainly described here. In the meaning, with respect to the following respective embodiments, the duplicate explanation is omitted.

The present embodiment is a modified example of the first embodiment and the digital signature generating apparatus 10 is divided into an authentication processing apparatus 17 with related to the authentication processing and a signature processing apparatus 18 with related to the signature processing.

Here, the authentication processing apparatus 17 includes the authentication information managing unit 11, the authentication unit 13, an assertion generating unit 15′, and a control unit 16′.

The authentication information managing unit 11 and the authentication unit 13 have the above-described functions.

The assertion generating unit 15′ is related to the user authentication system among the above-described functions of the assertion generating unit 15. Specifically, the assertion generating unit 15′ has a function to generate the first assertion for asserting the user authentication system when the result of the user authentication received from the authentication unit 13 via the control unit 16′ indicates validity and transmit this first assertion to the control unit 16′.

The control unit 16′ is connected to the digital signature generating apparatus 18 via wire communication or wireless communication and the control unit 16′ controls the authentication unit 13 and the assertion generating unit 15 among the functions of the control unit 16. The control unit 16′ is specifically provided with the following functions (f16′-1) to (f16′-4).

(f16′-1): A function to transmit the user authentication request received from the digital signature generating apparatus 18 to the authentication unit 13.
(f16′-2): A function to relay the communication between the user authentication processing by the authentication unit 13 and the external apparatus (namely, the communication to the client apparatus 20A via the digital signature generating apparatus 18).
(f16′-3): A function to generate the first assertion with related to the user authentication system by controlling the assertion generating unit 15′ when the result of the user authentication received from the authentication unit 13 indicates validity.
(f16′-4): A function to output the result of the user authentication and the first assertion to the signature processing apparatus 18 individually or simultaneously.

The authentication processing apparatus 17 may be provided to a cellular phone (Handset) and the like as the client apparatus 20A when it is realized as a tamper proof chip.

On the other hand, the signature processing apparatus 18 includes the key managing unit 12, the digital signature generating unit 14, an assertion generating unit 15″, and a control unit 16″.

The key managing unit 12 and the digital signature generating unit 14 have the above-described functions.

The assertion generating unit 15″ is related to the key management system among the above-described functions of the assertion generating unit 15 and specifically, the assertion generating unit 15″ is controlled by the control unit 16″ and has a function to generate the second assertion for asserting the key management system and transmit this second assertion to the control unit 16″.

The control unit 16″ is connected to the user authentication apparatus 17 via wire communication or wireless communication and the control unit 16″ controls the digital signature generating unit 14 and the assertion generating unit 15 among the functions of the control unit 16. The control unit 16″ is specifically provided with the following functions (f16″-1) to (f16″-5).

(f16″-1): A function to transmit the user authentication request for the generation request source of the digital signature to the user authentication apparatus 17 upon receipt of the generation request of the digital signature from the client apparatus 20A.
(f16″-2): A function to control the digital signature generating unit 14 so as to generate the digital signature by using the corresponding digital signature generation key in the key managing unit 12 when the result of the user authentication received from the user authentication apparatus 17 indicates validity.
(f16″-3): A function to control the assertion generating unit 15″ so as to generate the second assertion with related to the key management system when the result of the user authentication received from the user authentication apparatus 17 indicates validity.
(f16″-4): A function to apply the conversion processing to the digital signature received from the digital signature generating unit 14, the first assertion received from the user authentication apparatus 17, and the second assertion received from the assertion generating unit 15″ and relate the digital signature and the first and second assertion each other due to the acquired conversion value.
(f16″-5): A function to transmit the digital signature, the first and second assertion, and the conversion value to the client apparatus 20A.

According to the above-described system, the digital signature generating apparatus 10 according to the first embodiment is realized by the authentication processing apparatus 17 and the digital signature generating apparatus 18, so that a load of the digital signature generating apparatus 10 can be dispersed and a load of the authentication processing and the authentication information management processing in the digital signature generating apparatus 10 can be reduced.

### Third Embodiment

Next, third to fifth embodiments of the present invention will be described below. The third to fifth embodiments show examples of various systems to which the digital signature assurance system based on identity is applied. The identity-based (identification-based) digital signature assurance system is made by adding the assertion of the credentials to the digital signature. Here, the credential means the used authentication method and qualities of the used authentication method and the like. The credential is issued to an identity provider as assertion.

Specifically, such digital signature assurance adds the assertion of the credentials with related to usage of the private key to the digital signature to relate the digital signature to the (user) authentication. Thereby, the side to receive the digital signature can confirm the credential with respect to the digital signature such as “who passes what authentication by what right” on the basis of the assertion.

In this case, the identity means the identification information that is generated when a subject that account and attribution are connected to a real person (a principal) is authenticated. The identification information is not necessarily related to the real person and if it is justly authenticated by an identity provider, anonymity (attribution except for identity of the user) may be available. In other words, it is possible to represent the more flexible identification information.

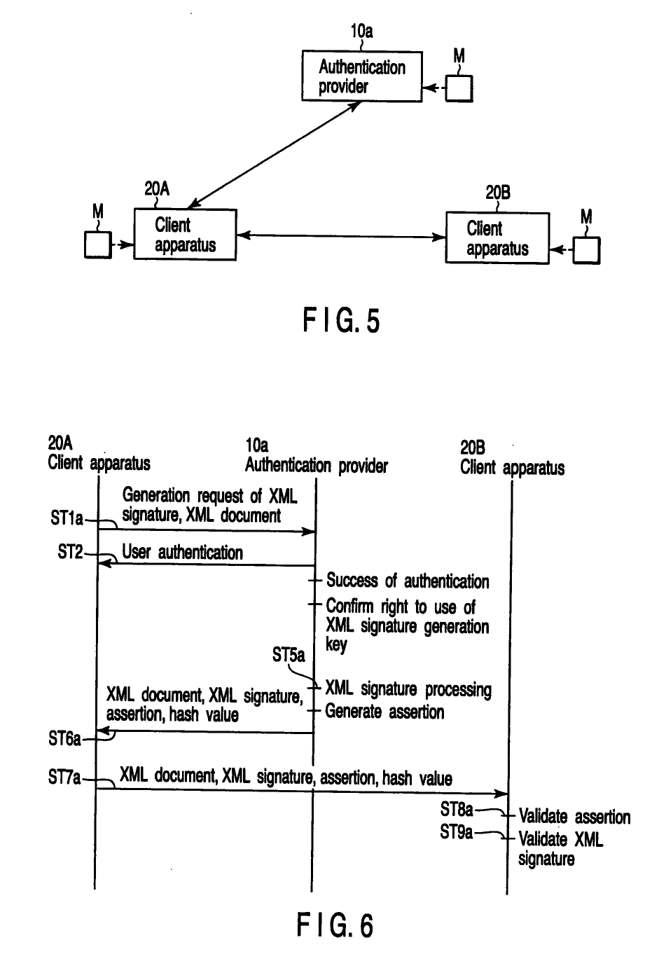

Next, the case of applying the above-described digital signature assurance system to the XML document transmission system will be described below. FIG. 5 is a pattern diagram showing a configuration of an XML document transmission system to which an digital signature assurance system according to a third embodiment of the present invention is applied. This XML document transmission system includes an identity provider (Idp) 10a in place of the digital signature generating apparatus 10 shown in FIG. 1.

In this case, the identity provider 10a is made by realizing the above-described digital signature generating apparatus 10 as a server and the identity provider 10a uses the XML document as the above-described digital document D and uses an XML signature as the above-described digital signature.

This XML signature is a digital signature that is generated from the XML document of the signature target by an XML signature generation key (the private key) of a group G to which a user S of the client apparatus 20A belongs (a business enterprise and a department and the like) and the XML signature assures that the document is created by the group G. The XML signature generation key of the group G is managed by the key managing unit 12 (not shown) of the identity provider 10a. In the same way, a right to use of the user S for the XML signature generation key of the group G is managed by the authentication information managing unit 11 (not shown) of the identity provider 10a.

Next, the above-described XML document transmission system will be described with reference to the sequence diagram shown in FIG. 6.

It is assumed that the user S wants to transmit a certain XML document (a contract document and the like) to other user R.

The client apparatus 20A transmits the generation request of the XML signature of the group G and the XML document of the signature target to the identity provider 10a due to the operation of the user S (ST1a).

Upon receipt of the generation request of the XML signature and the XML document, the identity provider 10a executes the user authentication for the user S of the client apparatus 20A as described above (ST2).

When the result of the user authentication indicates validity, the identity provider 10a confirms the right to use of the user S with respect to the XML signature generation key of the group G and generate the XML signature from the XML document by using this XML signature generation key (ST5a).

Then, the identity provider 10a issues assertion (the assertion) for asserting the key management system with respect to the XML signature generation key of the group G of the user S and the user authentication system with respect to the user S (the anonymity is also available) and applies the hash functions to both of the XML signature and the assertion so as to acquire the hash value.

Subsequently, the identity provider 10a sends back the XML document, the XML signature, the assertion and the hash value to the client apparatus 20A (ST6a).

The client apparatus 20A transmits the XML document, the XML signature, the assertion and the hash value to the client apparatus 20B of the user R due to the operation of the user S (ST7a).

The client apparatus 20B verifies assertion due to the operation of the user R as described above (ST8a) and verifies the XML signature (ST9a) to confirm validity of the XML signature.

As described above, according to the present embodiment, even if the digital signature assurance system of the first embodiment is applied to the XML document transmission system, it is possible to acquire the advantage as same as the first embodiment.

### Fourth Embodiment

Next, the forth embodiment of the present invention will be described below. In the third embodiment, the XML document exchange system (the group G is the business enterprise) due to B2B (business to business) is described, however, the XML document exchange system can be applied to arbitrary patterns such as B2G (business to government), C2G (citizen to government) and C2C (customer to customer) other than B2B. In other words, the digital signature assurance system according to the present invention and the XML document exchange system due to the digital signature assurance system can be applied to various exchanges of information through the document and the like in a real world. In the fourth embodiment, an example that the digital signature assurance system according to the present invention is applied to an digital commerce system of B2C will be described.

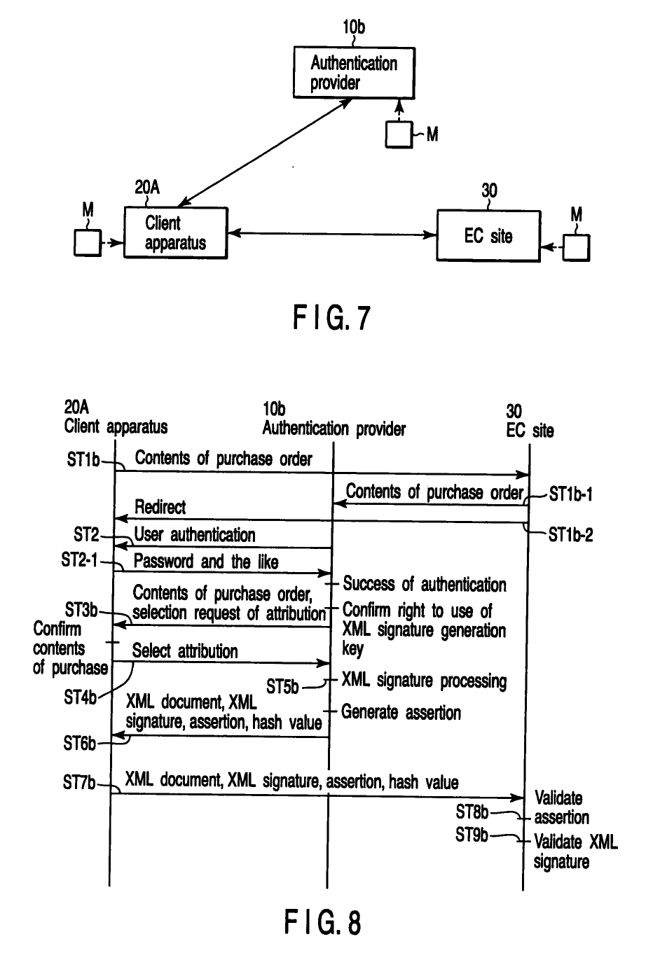

FIG. 7 is a pattern diagram showing a configuration of an digital commerce system to which an digital signature assurance system according to the fourth embodiment of the present invention is applied. This digital signature assurance system includes an identity provider (IdP) 10b for the digital commerce in place of the identity provider 10a shown in FIG. 5 and further, the system includes an digital commerce site (EC site) 30 in place of the client apparatus 20B shown in FIG. 5.

In this case, the identity provider 10b provides an digital signature service for the user while providing the authentication service for the EC site 30 and specifically, the identity provider 10b has the following functions (f10b-1) to (f10b-5).

(f10b-1): A function to execute the user authentication with respect to the user who has been registered in advance.
(f10b-2): A function to create the XML document and the XML signature on the basis of the contents of purchase order of the user.
(f10b-3): A function to create assertion on the basis of the user authentication system, the key management system, and the attribution information of the user.
(f10b-4): A function to relate the XML document, the XML signature, and the assertion by the hash value.
(f10b-5): A function to transmit the XML document, the XML signature, the assertion, and the hash value to the client apparatus 20A of the user.

Here, the identity provider 10b creates the XML document, however, the client apparatus 20A may create the XML document other than this. However, it is preferable that the XML document of the purchase order is created by the identity provider 10b because errors such as incomplete entry of necessary items can be prevented by inquiry to the user.

The EC site 30 is a website selling a commodity for an individual that is run by a server (not shown) and it has the following functions (f30-1) to (f30-3).

(f30-1): A function to transmit the contents of a purchase order received from the client apparatus 20A to the identity provider 10b.
(f30-2): A function to make the identity provider 10b to execute the user authentication of the user of the client apparatus 20A by redirection.
(f30-3): A function to sell the commodity on the basis of the XML document (the contents of the purchase order, the attribution) received from the client apparatus 20A, the XML signature, the assertion and the hash value.

Next, the operation of the above-described digital commerce system will be described with reference to the sequence diagram shown in FIG. 8.

The client apparatus 20A visits the EC site 30 for selling the commodity due to the operation of the user and writes the contents of the purchase order in a purchase form of the commodity (ST1b).

The EC site 30 transmits the contents of the purchase order to the identity provider 10b as the XML data (ST1b-1) and redirects the client apparatus 20A to an authentication page of the identity provider 10b (ST1b-2).

Upon receipt of the contents of the purchase order, the identity provider 10b executes the user authentication of the user of the client apparatus 20A (ST2). In this case, as the user authentication, for example, a password and the public key certification based authentication and the like are used (ST2-1).

The identity provider 10b confirms the right to use of the user for the XML signature generation key when the result of the user authentication indicates validity and transmits a selection request of the attribution in which the contents of the purchase order is filled to the client apparatus 20A (ST3b).

The client apparatus 20A indicates the contents of the purchase order and the selection request of the attribution and confirms the contents of the purchase order due to the operation of the user and further, the client apparatus 20A selects the attribution information (a real name or an anonymity and an address and the like) disclosed in the EC site 30 (ST4b).

The identity provider 10b creates the XML document from the contents of the purchase order after confirmation and by using the XML signature generation key, the identity provider 10b creates the XML signature from the XML document (ST5b). In addition, the identity provider 10b generates assertion including the user authentication system, the key management system and the attribution information of the user and provides the hash functions to both of the XML signature and the assertion to acquire the hash value.

Subsequently, the identity provider 10b sends back the XML document, the XML signature, the assertion, and the hash value to the client apparatus 20A (ST6b).

The client apparatus 20A transmits the XML document, the XML signature, the assertion, and the hash value to the EC site 30 due to the operation of the user (ST7b).

The EC site 30 verifies the assertion as described above (ST8b) and verifies the XML signature (ST9b) to confirm validity of the XML signature. Due to this verification of the assertion, the user authentication is completed and due to verification of the XML signature, validity of the contents of the purchase order is confirmed, so that the EC site 30 accepts the purchase order and shifts to the distribution order processing and the settlement processing of the like of the commodity.

As described above, according to the present embodiment, if each system of the first or the third embodiment is applied to the digital commerce system, it is possible to acquire the same advantages as the first or the third embodiment.

In addition, a third party can confirm the user authentication and the purchase intention that are necessary for the digital commerce. For example, in the case of a purchase scheme on the Web, it is general that the user frequently writes the contents of the purchase order in a form of the purchase order and transmits it. However, in the case of the purchase order due to the digital document, it is difficult for the third party to confirm the fact that the user orders the purchase because a signature of original handwriting and impression of a seal are not left differently from the purchase order due to paper. On the other hand, according to the present embodiment, the user authentication and the XML signature are connected by the assertion, so that it is possible to satisfy the requirements (the authentication and the assertion of the intention) that are necessary for the digital commerce.

In addition, the digital commerce system according to the present embodiment can assure that the XML document (the contents of the purchase order) is not falsified by the XML signature differently from the conventional paper-based trading. Thereby, it is possible to enhance the evidentiary base of the contents of the purchase order and it is possible to contribute to development of more safe digital commerce.

### Fifth Embodiment

Next, the fifth embodiment of the present invention will be described below. In the present embodiment, an digital bidding system available for B2B, B2B2E (business to business to employee) or C2C and the like is taken as an example. In this case, the digital bidding system is a business pattern to establish a temporary trading relation and it is assumed that the enterprises having no trading in the past mainly become the users. Generally, it is preferable to search the credit information of a business partner despite of with or without of the trading record. However, it is difficult to search the credit information of the business partner for each temporal trading in fact because it is so troublesome.

Therefore, in the present embodiment, the digital bidding system capable of providing one's credit information simply and rapidly to a trading partner will be described as an example.

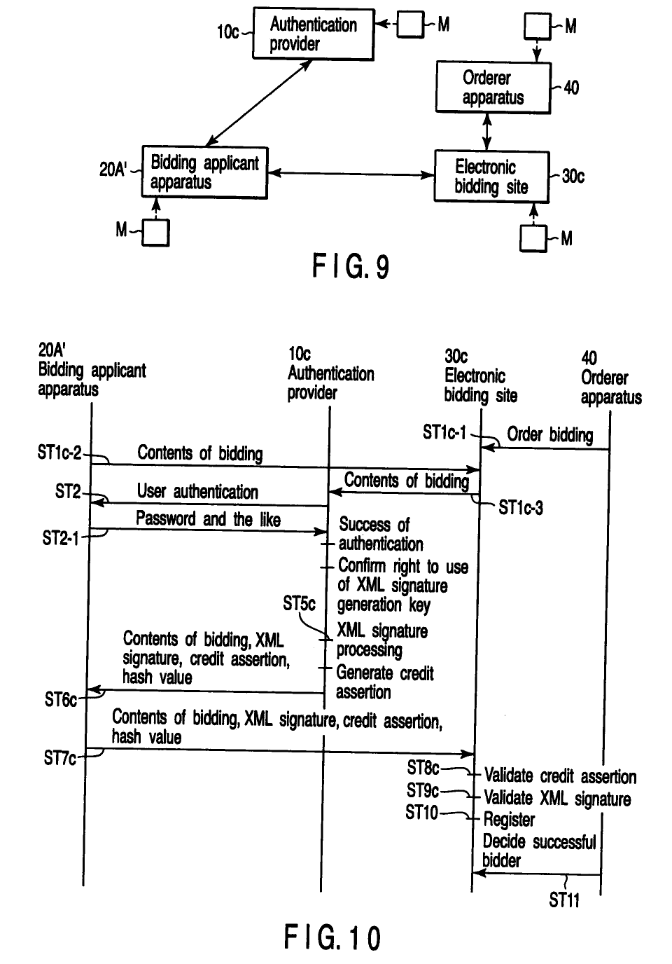

FIG. 9 is a pattern diagram showing a configuration of an digital bidding system to which an digital signature assurance system according to the fifth embodiment of the present invention is applied. This digital bidding system includes an identity provider (IdP) 10c for the digital bidding in place of the identity provider 10a and includes a bidding applicant apparatus 20A′ in place of the client apparatus 20A show in FIG. 5. In addition, the digital bidding system includes an digital bidding site 30c in place of the client apparatus 20B shown in FIG. 5 and further includes an orderer apparatus 40 capable of communicating to the digital bidding site 30c.

The identity provider 10c provides the digital signature service to the bidding applicant while providing the authentication service to the digital bidding site 30c. Specifically, the identity provider 10c has the following functions (f10c-1) to (f10c-5).

(f10c-1): A function to carry out the execution of the user authentication for the bidding applicant who has registered in advance.
(f10c-2): A function to generate the XML signature from the XML document (the contents of bidding) of the bidding applicant.
(f10c-3): A function to generate assertion including the user authentication system and the key management system and create the assertion with the credit information by adding the credit information of the bidding applicant who has been registered in advance to this assertion and create the assertion with the credit information (credit assertion).
(f10c-4): A function to relate the XML document, the XML signature, and the credit assertion by the hash value.
(f10c-5): A function to transmit the XML document, the XML signature, the credit assertion and the hash value to the bidding applicant apparatus 20A′.

In this case, the bidding applicant apparatus 20A′ creates the XML document, however, the present embodiment is not limited to this and the present embodiment may be modified so that the XML document is created at the side of the identity provider 10c in response to the input content of the above-described bidding applicant apparatus 20A′.

The bidding applicant apparatus 20A′ is a terminal apparatus having normal computer function and communication function and executes the different operations depending on the operation of the user. This is the same as the orderer apparatus 40.

Specifically, the bidding applicant apparatus 20A′ is used by a transmitter of the digital information when performing the digital bidding in the digital bidding site 30c and the bidding applicant apparatus 20A′ has the following functions (f20A′-1) to (f20A′-3).

(f20A′-1): A function to transmit the contents of bidding to the digital bidding site 30c due to the operation of the bidding applicant (the user).
(f20A′-2): A function to transmit the authentication information to the identity provider 10c in accordance with the authentication request from the identity provider 10c.
(f20A′-3): A function to transmit the XML document (the contents of bidding), the XML signature, the credit assertion and the hash value that are received from the identity provider 10c to the digital bidding site 30c.

The digital bidding site 30c is a website mediating the bidding before the enterprises (respective apparatus 20A′ and 40) trade each other and the digital bidding site 30c has the following functions (f30c-1) to (f30c-3).

(f30c-1): A function to transmit the bidding contents received from the bidding applicant apparatus 20A′ to the identity provider 10c and make the identity provider 10c to execute the user authentication.
(f30c-2): A function to verify the validations of the XML document (the contents of bidding), the XML signature, the credit assertion and the hash value that are received from the bidding applicant apparatus 20A′.
(f30c-3): A function to present the bidding contents and the credit assertion of the bidding applicant apparatus 20A′ to the orderer apparatus 40 after verifying the validations.

The orderer apparatus 40 is used by the side receiving the digital information when performing the digital bidding by the digital bidding site 30c and the orderer apparatus 40 has the following functions (f40-1) to (f40-3).

(f40-1): A function to transmit the bidding conditions to the digital bidding site 30c and order the digital bidding due to the operation of the orderer.
(f40-2): A function to decide a successful bidder in the bidding on the basis of the contents of the bidding and the credit assertion that are presented by the digital bidding site 30c.
(f40-3): A function to notify the digital bidding site 30c of the decided contents.

Next, the operation of the above-described digital bidding system will be described below with reference to the sequence diagram shown in FIG. 10.

The orderer apparatus 40 transmits the bidding conditions to the digital bidding site 30c due to the operation of the orderer and orders the digital bidding (ST1c-1).

The digital bidding site 30c publishes a website of the digital bidding on the basis of a bidding condition received from the orderer apparatus 40 on a network.

The bidding applicant apparatus 20A′ visits the digital bidding site 30c due to the operation of the bidding applicant and writes the contents of the bidding therein (ST1c-2).

The digital bidding site 30c transmits the bidding contents to the identity provider 10c as the XML document (ST1c-3) and requires the user authentication of the bidding applicant apparatus 20A′ from the identity provider 10c.

Receiving the contents of the bidding, the identity provider 10c executes the user authentication with respect to the bidding applicant (ST2). In this case, as the user authentication, for example, a password and the public key certification based authentication and the like are used (ST2-1).

The identity provider 10c confirms the right to use of the bidding applicant for the XML signature generation key when the result of the user authentication indicates validity and creates the XML signature from the XML document (the bidding contents) by using the XML signature generation key (ST5c). In addition, the identity provider 10c creates the assertion including the user authentication system and the key management system and makes this assertion into the credit assertion by adding the credit information of the bidding applicant to the assertion. Then, the identity provider 10c applies the hash functions to both of the XML signature and the credit assertion to acquire the hash value.

Subsequently, the identity provider 10c sends back the XML document, the XML signature, the credit assertion, and the hash value to the client apparatus 20A′ (ST6c).

The client apparatus 20A′ transmits the XML document, the XML signature, the assertion, and the hash value to the digital bidding site 30c due to the operation of the user (ST7c).

The digital bidding site 30c verifies the credit assertion as described above (ST8c) and verifies the XML signature (ST9c) to confirm validity of the XML signature. Due to this verification of the credit assertion, the user authentication is completed and due to verification of the XML signature, validity of the contents of the bidding is confirmed, so that digital bidding site 30c registers the contents of the bidding and the credit assertion (ST10) and enables the orderer apparatus 40 to browse the registered contents.

The orderer apparatus 40 displays and browses the registered contents of the digital bidding site 30c due to the operation of the orderer. The orderer apparatus 40 decides the successful bidder of trading on the basis of the contents of the bidding and the credit information, and notifies the digital bidding site 30c of the decided contents (ST11).

As described above, according to the present embodiment, even if each system of the first or the third embodiment to the digital bidding system, the same advantages as the first or the third embodiment can be acquired.

In addition, not limited to the trading between the enterprises, the present invention can be also applied to the trading between the individuals. For example, there is generally no reliable relation between the individual presenter of the commodity and the individual purchaser and it is difficult for the individuals to mutually search creditworthiness such as presentation of a damaged commodity and an outstanding balance. Therefore, it is effective that the digital bidding system according to the present embodiment is also applied to the trading between the individuals to provide the credit assertion including credit information of the individual.

In the meantime, the methods described in the above embodiments may be stored in a storage media such as a magnetic disk (such as a floppy (registered trademark) disk and a hard disk), an optical disk (such as CD-ROM and DVD), and a magnetic optical disk (MO), and a semiconductor memory and the like as a program capable of being executed by a computer to be distributed.

In addition, as this storage media, any pattern of a storage system is available if that storage media can store the program and can be read by the computer.

In addition, respective processing for realizing the present embodiment may be partially executed by an operating system (OS) and a middle ware (MW) such as a database management software, a network software, and the like that are activated on the computer on the basis of the instruction of the program installed in the computer from the storage media.

Further, the storage media of the present invention is not limited to a media independent from the computer and includes the storage media that downloads and stores or temporarily stores the program transmitted form the LAN and Internet and the like.

In addition, the storage media of the present invention is not limited to one media, and plural media to execute the processing in the present embodiment may be available and any configuration is possible as the configuration of the media.

In the meantime, the computer according to the present invention executes respective processing in the present embodiment on the basis of a program that is stored in the storage media and has any configuration such as an apparatus made of a personal computer and the like and a system having a plurality of apparatuses connected through the network and the like.

In addition, the computer according to the present invention is not limited to the personal computer and includes an arithmetic processor included in an information processor and a microcomputer and the like. In other words, the computer generically names a device and an apparatus capable of realizing the functions of the present invention by a program.

In the meantime, the present invention is not limited to the above-described embodiments as it is and in a practical stage, it is possible to modify the constituent elements of the present invention without departing from the scope thereof. In addition, various inventions can be made by appropriate combinations of plural constituent elements that are disclosed in the above-descried embodiment. For example, some constituent elements may be deleted from all constituent elements that are shown in the embodiments. Further, the constituent elements of the different embodiments may be arbitrarily combined.

1-10. (canceled)

11. An digital signature generating apparatus, which is provided so as to be communicated to the user authentication apparatus for executing a user authentication in accordance with a user authentication system that has been set in advance upon receipt of a request of the user authentication; generating the first assertion for asserting the user authentication system when a result of this user authentication indicates validity; and outputting the result of the user authentication and the first assertion, the apparatus comprising:
a key management device configured to manage an digital signature generation key in accordance with a key management system that has been set in advance for each generation request source of the digital signature;
an authentication request transmission device configured to transmit a user authentication request for the generation request source of the digital signature to the user authentication apparatus upon receipt of the generation request of the digital signature;
an digital signature generation device configured to generate the digital signature by using the corresponding digital signature generation key in the key management device when a result of this user authentication received from the user authentication apparatus indicates validity;
a second assertion generation device configured to generate the second assertion for asserting the key management system;
means for applying the conversion processing to the digital signature and the first and second assertion and relating the digital signature and the first and second assertion each other by the acquired conversion value; and
an output device configured to output the digital signature, the first and second assertion, and the conversion value.

12. The digital signature generating apparatus according to claim 11, wherein
the conversion processing is an arithmetic processing of the hash function,
the conversion value is a hash value.

13. The digital signature generating apparatus according to claim 11, wherein
the conversion processing is the signature processing using a private key specific to the digital signature generating device,
the conversion value is a second digital signature.
